(19) United States
(12) Patent Application Publication
(10) Pub. No.: US 2026/0197886 A1
(43) Pub. Date: Jul. 9, 2026

(54) METHOD OF CONTROLLING SPLIT BEARER IN DUAL CONNECTIVITY AND APPARATUS SUPPORTING THE METHOD

(71) Applicant: ELECTRONICS AND TELECOMMUNICATIONS RESEARCH INSTITUTE, Daejeon (KR)

(72) Inventors: Yunhee Cho, Daejeon (KR); JeeHyeon Na, Daejeon (KR)

(21) Appl. No.: 19/431,209

(22) Filed: Dec. 23, 2025

(30) Foreign Application Priority Data
Jan. 6, 2025 (KR) 10-2025-0001334
Jun. 19, 2025 (KR) 10-2025-0080759

(51) Int. Cl. H04W 76/15; H04L 43/0876; H04W 76/20

(52) U.S. Cl. CPC H04W 76/15; H04L 43/0876; H04W 76/20

(57) ABSTRACT

Disclosed is a method of controlling a split bearer in a wireless communication system supporting dual connectivity. The method performed by UE includes receiving an RRC message, including first control information related to the configuration of a split bearer and second control information related to the setting of a data split threshold, from a base station, setting a split threshold of uplink data based on the second control information with respect to the split bearer configured based on the first control information, transmitting a first PDCP control PDU that requests an update of the set split threshold of the uplink data to the base station, receiving a second PDCP control PDU corresponding to a response to the first PDCP control PDU from the base station, and updating the split threshold of the uplink data based on the second PDCP control PDU.

### CROSS-REFERENCE TO RELATED APPLICATIONS

This application claims the benefit of and priority to Korean Patent Application No. 10-2025-0001334, filed on Jan. 6, 2025 and Korean Patent Application No. 10-2025-0080759, filed on Jun. 19, 2025, the entire disclosure(s) of which is hereby incorporated herein by reference in its entirety.

### BACKGROUND

### 1. Technical Field

This specification relates to a method of controlling a split bearer in a dual connectivity structure of a wireless communication system, and particularly, to a method of efficiently transmitting data traffic by using a split bearer in a PDCP layer when UE has dual connectivity with a plurality of base stations.

### 2. Related Art

A PDCP layer based on 3GPP 5G NR supports a data transmission function, a PDCP sequence numbers (SN) maintenance function, a header compression and recovery function (using an ROHC protocol), a ciphering and deciphering function, an integrity protection and integrity verification function, a discard timer-based SDU deletion function, a routing function for a split bearer, a duplication function, a reordering and in-order delivery function or an out-of delivery function, and a duplicate discarding function for a user plane or a control plane, and selectively provides a data transmission function and a header compression, ciphering, or integrity protection service to an RRC or SDAP layer that is a higher layer.

In a dual connectivity structure, a transmission PDCP entity in which a split bearer has been configured transmits data by dividing a PDCP data PDU data transmission path into a master cell group (MCG) and a secondary cell group (SCG). The transmitted data is reassembled in the PDCP layer on the reception side. From the viewpoint of a terminal, the PDCP data PDU transmission path for the split bearer is based on an uplink data split threshold set through an RRC message.

### SUMMARY

Various embodiments are directed to providing a method of controlling split bearer data transmission for efficiently transmitting data traffic of UE based on a change in the channel state of UE in which a split bearer has been configured or a change in the load of the base station.

That is, various embodiments of this specification are directed to proposing a method of efficiently controlling a split bearer in a PDCP layer in the dual connectivity structure of a wireless communication system and to improving performance of UE having dual connectivity with a plurality of base stations and increasing use efficiency of radio resources.

Technical objects to be achieved by the present disclosure are not limited to the aforementioned object, and the other objects not described above may be evidently understood from the following description by a person having ordinary knowledge in the art to which the present disclosure pertains.

In this specification, in a method of controlling a split bearer in a wireless communication system supporting dual connectivity, the method performed by UE includes receiving an RRC message, including first control information related to the configuration of a split bearer and second control information related to the setting of a data split threshold, from a base station, setting a split threshold of uplink data based on the second control information with respect to the split bearer configured based on the first control information, transmitting a first PDCP control PDU that requests an update of the set split threshold of the uplink data to the base station, receiving a second PDCP control PDU corresponding to a response to the first PDCP control PDU from the base station, and updating the split threshold of the uplink data based on the second PDCP control PDU.

Furthermore, in this specification, the first control information is a moreThanOneRLC field. The second control information is an UL-DataSplitThreshold field.

Furthermore, in this specification, the first PDCP control PDU and the second PDCP control PDU each include a D/C field, a PDU type field, a message type field, and an UL-DataSplitThreshold field.

Furthermore, in this specification, the PDU type field included in the first PDCP control PDU is set as a value indicative of the update of the data split threshold.

Furthermore, in this specification, the message type field included in the first PDCP control PDU is set as a value requesting the update of the data split threshold. The message type field included in the second PDCP control PDU is set as a value indicative of a response to a request for the update of the data split threshold.

Furthermore, in this specification, the method further includes measuring the volume of data to be transmitted based on the configured split bearer and comparing the measured volume of the data and the set split threshold of the uplink data.

Furthermore, in this specification, the volume of the data is measured based on the sum of the volume of PDCP data and the volume of RLC data that waits for initial transmission.

Furthermore, in this specification, when the measured volume of the data is equal to or greater than the set split threshold of the uplink data, a PDCP data PDU is transmitted from a PDCP entity to a primary RLC entity and a split secondary RLC entity.

Furthermore, in this specification, when the measured volume of the data is smaller than the set split threshold of the uplink data, a PDCP data PDU is transmitted from a PDCP entity to a primary RLC entity.

Furthermore, in this specification, when performance degradation is detected in the primary RLC entity, updates are performed on the split threshold of the uplink data.

Furthermore, in this specification, in a method of controlling a split bearer in a wireless communication system supporting dual connectivity, the method performed by a base station includes transmitting an RRC message, including first control information related to the configuration of a split bearer and second control information related to the setting of a threshold for a data split, to UE, updating a split threshold of uplink data when the split threshold of the uplink data configured based on the second control information needs to be changed, and transmitting a PDCP control PDU including the updated split threshold of the uplink data to the UE.

Furthermore, in this specification, when performance degradation is detected in at least one of a primary path or secondary path for the split bearer, updates are performed on the split threshold of the uplink data.

Furthermore, in this specification, when a load of the base station is detected, updates are performed on the split threshold of the uplink data.

Furthermore, according to this specification, user equipment for controlling a split bearer in a wireless communication system supporting dual connectivity includes an RF module configured to transmit and receive radio signals to and from a base station and a processor functionally connected to the RF module and configured to control an overall operation of the UE. The processor controls to receive an RRC message, including first control information related to the configuration of a split bearer and second control information related to the setting of a data split threshold, from a base station, set a split threshold of uplink data based on the second control information with respect to the split bearer configured based on the first control information, transmit a first PDCP control PDU that requests an update of the set split threshold of the uplink data to the base station, receive a second PDCP control PDU corresponding to a response to the first PDCP control PDU from the base station, and update the split threshold of the uplink data based on the second PDCP control PDU.

Furthermore, in this specification, the processor controls to measure the volume of data to be transmitted based on the configured split bearer and to compare the measured volume of the data and the set split threshold of the uplink data.

Furthermore, in this specification, the processor measures the volume of the data as the sum of the volume of PDCP data and the volume of RLC data that waits for initial transmission.

Furthermore, in this specification, the processor transmits a PDCP data PDU from a PDCP entity to a primary RLC entity when the measured volume of the data is smaller than the set split threshold of the uplink data, and performs updates on the split threshold of the uplink data when performance degradation is detected in the primary RLC entity.

This specification has effects in that performance degradation of UE can be rapidly reduced and use efficiency of radio resources can be improved by efficiently using a split bearer because a threshold for the split of uplink data traffic is rapidly updated based on a PDCP control PDU between peer PDCPs based on a change in the channel state of UE or the load of a base station when the UE is configured with the split bearer in the dual connectivity structure of a wireless communication system.

Effects of the present disclosure which may be obtained in the present disclosure are not limited to the aforementioned effects, and the other effects not described above may be evidently understood by a person having ordinary knowledge in the art to which the present disclosure pertains from the following description.

### BRIEF DESCRIPTION OF THE DRAWINGS

The accompanying drawings, which are included as part of the detailed description in order to help understanding of the present disclosure, provide embodiments of the present disclosure and describe the technical characteristics of the present disclosure along with the detailed description.

FIG. 1 is a diagram illustrating examples of MR-DC to which a method proposed in this specification may be applied.

FIG. 2 illustrates an example of a radio protocol structure for UE-aspect MCG, SCG, and split bearers in MR-DC to which a method proposed in this specification may be applied.

FIG. 3 illustrates an example of protocol termination points for network-aspect MCG, SCG, and split bearer options in MR-DC to which a method proposed in this specification may be applied.

FIG. 4 is a diagram illustrating an example of a count format.

FIG. 5 is a flowchart illustrating an example of a method of updating a split bearer data split threshold in a dual connectivity structure proposed in this specification.

FIG. 6 illustrates an example of a PDCP control PDU format for the update of a data split threshold, which is proposed in this specification.

FIG. 7 is a flowchart illustrating an example of a data split threshold update method triggered in UE, which is proposed in this specification.

FIG. 8 is a flowchart illustrating an example of a data split threshold update method triggered in a base station, which is proposed in this specification.

FIG. 9 illustrates a block diagram of a wireless communication apparatus to which the methods proposed in this specification may be applied.

### DETAILED DESCRIPTION

It is to be noted that technological terms used in this specification are used to describe only specific embodiments and are not intended to limit this specification. Furthermore, the technological terms used in this specification should be construed as having meanings that are commonly understood by those skilled in the art to which this specification pertains unless especially defined as different meanings otherwise in this specification, and should not be construed as having excessively comprehensive meanings or excessively reduced meanings. Furthermore, if the technological term used in this specification is a wrong technological term that does not precisely represent the spirit of a technology disclosed in this specification, the technological term should be replaced with a technological term which may be correctly understood by a person having ordinary knowledge in the field disclosed in this specification and understood. Furthermore, common terms used in this specification should be interpreted in accordance with the definition of dictionaries or in accordance with the context, and should not k construed as having excessively reduced meanings.

Furthermore, terms including ordinal numbers, such as a “first” and a “second”, which are used in this specification, may be used to describe various components, but the components are not restricted by the terms. The terms are used to only distinguish one component from the other components. For example, a first component may be named a second component without departing from the scope of rights of this specification. Likewise, the second component may be named the first component.

Hereinafter, embodiments according to this specification are described in detail with reference to the accompanying drawings. The same or similar component is assigned the same reference numeral regardless of its reference numeral, and a redundant description thereof is omitted.

Furthermore, in describing this specification, a detailed description of a related known technology will be omitted if it is deemed to make the subject matter of this specification unnecessarily vague. Furthermore, the accompanying drawings are merely intended to make easily understood the spirit of this specification, and the spirit of this specification should not be construed as being restricted by the accompanying drawings.

Hereinafter, a method of efficiently controlling a split bearer in the dual connectivity structure of a wireless communication system, which is proposed in this specification, is described in detail with reference to related drawings.

Multi-radio dual connectivity (MR-DC) is the generalization of dual connectivity (DC), and may be configured so that a terminal (e.g., user equipment (UE)) capable of multi-transmission and reception uses resources provided by two different nodes connected through a non-ideal backhaul. One node provides NR access, and the other node provides E-UTRA or NR access. In this case, one node plays a role as a master node (MS), and the other node plays a role as a secondary node (SN).

Examples of the configuration of the MR-DC include E-UTRA-NR dual connectivity (EN-DC), NG-RAN E-UTRA-NR dual connectivity (NGEN-DC), NR-E-UTRA dual connectivity (NE-DC), and NR dual connectivity (NR-DC).

The MR-DC having connectivity with EPC includes E-UTRA-NR dual connectivity (EN-DC). Dual connectivity is supported for UE through an eNB operating as an MN and an en-gNB operating as an SN.

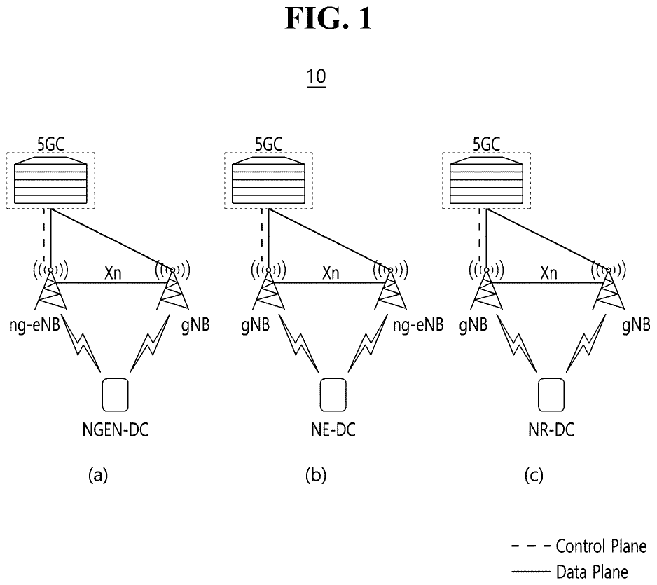

FIG. 1 is a diagram illustrating examples of MR-DC to which a method proposed in this specification may be applied. Referring to FIG. 1, MR-DC having connectivity with 5GC includes NG-RAN E-UTRA-NR dual connectivity (NGEN-DC) (FIG. 1(a)), NR-E-UTRA dual connectivity (NE-DC) (FIG. 1(b)), and NR dual connectivity (NR-DC) (FIG. 1(c)). In the NG-RAN E-UTRA-NR dual connectivity (NGEN-DC), dual connectivity is supported for UE through an ng-eNB operating as an MN and a gNB operating as an SN. In the NR-E-UTRA dual connectivity (NE-DC), dual connectivity is supported for UE through a gNB operating as an MN and an ng-eNB operating as an SN. In the NR dual connectivity (NR-DC), dual connectivity is supported for UE through one gNB operating as an MN and the other gNB operating as an SN.

In the MR-DC, UE has a single RRC state based on RRC of the MN and a single control plane connection toward a core network (CN). An RRC PDU generated by the SN may be transmitted to the UE through the MN. The MN provides wide coverage by a role of maintaining major control signals and data between the UE and the network. The SN is basically responsible for high-speed data transmission in a narrow range in order to supplement the MN, and operates within coverage of the MN.

In this specification, a configuration, among the configurations of the MR-DC, is described based on MR-DC having connectivity with 5GC (i.e., MR-DC with 5GC).

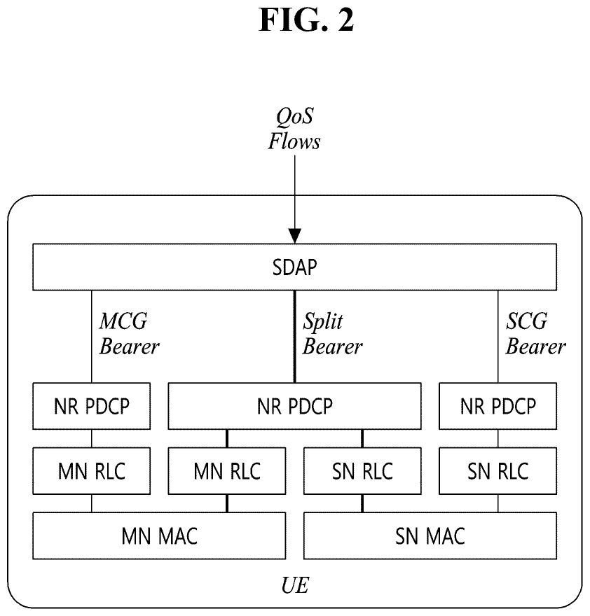

In the MR-DC having connectivity with 5GC, from the viewpoint of UE, three bearer types of MCG, SCG, and split bearers are present as illustrated in FIG. 2. An NR PDCP is used in all of the bearers.

FIG. 2 illustrates an example of a radio protocol structure for UE-aspect MCG, SCG, and split bearers in MR-DC to which a method proposed in this specification may be applied.

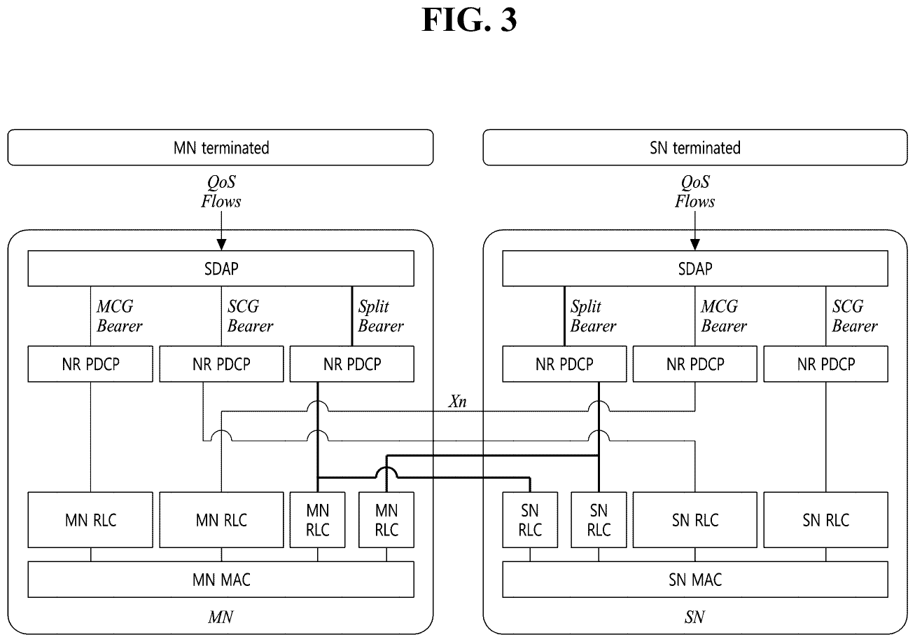

In the MR-DC having connectivity with 5GC, from the viewpoint of a network, each of the bearers (i.e., the MCG, SCG, and split bearers) may be terminated in an MN or an SN as illustrated in FIG. 3. The bearers are divided into an MN-terminated bearer and an SN-terminated bearer depending on user plane connection options for UE, and six bearer types are supported as illustrated in FIG. 3. FIG. 3 illustrates an example of protocol termination points for network-aspect MCG, SCG, and split bearer options in the MR-DC to which a method proposed in this specification may be applied.

Classification According to U-Plane Connectivity with CN
MN-terminated bearer-a user plane connection with a CN is terminated in an MN. In this case, a PDCP is placed in the MN.
SN-terminated bearer-a user plane connection with a CN is terminated in an SN. In this case, a PDCP is placed in the SN.

### Classification Depending on Whether MCG/SCG Radio Resources are Used on an Uu Interface

MCG bearers-only MCG radio resources are used
SCG bearers-only SCG radio resources are used
Split bearers-both MCG and SCG radio resource are used

In the case of the split bearer, the MN-terminated SCG bearer, and the SN-terminated MCG bearer, among the bearers, PDCP data is transmitted through an MN-SN user plane interface between the MN and the SN. The split bearer is transmitted to the UE by using all of the MN and SN radio resources (MCG and SCG). A data split is performed through the routing function in the PDCP layer.

A function and operation of a PDCP layer based on 3GPP 5G NR is described in brief.

The function of the PDCP layer is divided into a transmission PDCP entity function and a reception PDCP entity function. The transmission PDCP entity receives a PDCP SDU from an upper layer, assigns a sequence number to the PDCP SDU, performs a PDCP PDU configuration function on a signaling radio bearer (SRB) and a data radio bearer (DRB) depending on the type of bearer, and then transmits the PDCP PDU to a lower layer (e.g., an RLC layer).

The transmission PDCP entity assigns a SN to a reception PDCP SDU on the basis of a COUNT value of TX_NEXT. The reception PDCP entity manages and operates COUNT values of RX_DELIV and RX_NEXT based on RCVD_COUNT determined based on the SN of a received PDCP data PDU. The COUNT value that is managed by the transmission PDCP entity is TX_NEXT and is a COUNT value to be allocated to a next PDCP SDU.

The COUNT value that is managed by the reception PDCP entity is RX_NEXT, RX_DELIV, and RX_REORD. RX_NEXT is a COUNT value that is expected to be subsequently received. RX_DELIV has not been transmitted to an upper layer, and is a COUNT value of the first PDCP SDU that the upper layer still waits for. RX_REORD indicates a COUNT value subsequent to a COUNT value related to a PDCP data PDU that triggers t-reordering. A received PDCP determines a window size based on the size of a PDCP SN (Window Size=2 [pdcp-SN-Size]−1, a reordering window), and uses a reception window.

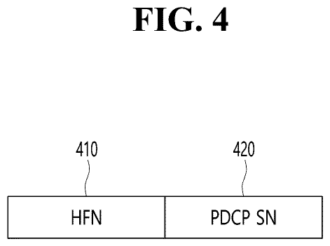

FIG. 4 is a diagram illustrating an example of a count format. Referring to FIG. 4, the count format may include a high frequency number (HFN) field 410 and a PDCP SN field 420.

Functions that are performed on an RB by the transmission PDCP entity are described as follows.
\textcircled{1} A PDCP SDU received from an upper layer is stored in a transmission buffer, and discardTimer for a PDCP SDU (when configured, DRB only) is started.
\textcircled{2} A COUNT value for the PDCP SDU is set as TX_NEXT.
\textcircled{3} A header compression function is performed on the PDCP SDU (when configured, DRB Only). When header compression is performed, the header compression is performed on only an SDAP SDU other than an SDAP header.
\textcircled{4} Integrity protection and ciphering are performed by using TX_NEXT (when configured). When the integrity protection is performed, MAC-I is generated by adding a PDCP header. When the ciphering is performed, only the SDAP SDU other than the PDCP header and the SDAP header is ciphered.
\textcircled{5} The PDCP SN value of the PDCP data PDU is set as TX_NEXT modulo 2 [pdcp-SN-Size]. The length of the PDCP SN is set to 12 bits or 18 bits based on a bearer configuration in an upper layer in the case of a DRB.
\textcircled{6} A TX_NEXT value is increased by 1.
\textcircled{7} A completed PDCP data PDU is transmitted to a lower layer.
\textcircled{8} When the PDCP data PDU is transmitted to the lower layer, if two RLCs are associated with the transmitted PDCP, the routing or duplication function is performed. If duplication has been configured, one PDCP data PDU is duplicated and transmitted to two transmission RLCs. In addition, in the case of the split bearer, the routing function that transmits the PDCP data PDU to one of two RLCs associated is performed.

The integrity protection and ciphering function during the aforementioned PDCP procedures is configured as essential with respect to an SRB, and is configured as optional with respect to a DRB.

Functions that are performed on an RB in the reception PDCP entity are described as follows.
\textcircled{1} An RCVD_COUNT is determined based on a PDCP SN extracted from a header with respect to a PDCP data PDU received from a lower layer.
\textcircled{2} Deciphering (when configured) and integrity verification (when configured) are performed by using RCVD_COUNT.
\textcircled{3} When the integrity verification fails, the failure is reported to an upper layer, and the corresponding PDCP data PDU is discarded.
\textcircled{4} when the RCVD_COUNT value of the received PDCP data PDU is smaller than RX_DELIV indicative of the COUNT value of the first PDCP SDU that has not yet been transmitted to an upper layer (RCVD_COUNT<RX_DELIV), the received PDCP data PDU is discarded.
\textcircled{5} If the COUNT (=RCVD_COUNT) value of the received PDCP data PDU has been previously received, the received PDCP data PDU is discarded.
\textcircled{6} If the PDCP data PDU has not been deleted during the procedure, a PDCP SDU is stored in the reception buffer and a function for in-order delivery or out-of delivery is performed.

In the case of the in-order delivery, it is identified whether PDCP packets have been sequentially arrived based on the COUNT value. When the sequence of the PDCP packets is wrong, the reordering timer is started. While the reordering timer operates, the PDCP entity waits for packets having a wrong sequence and rearranges the packets. When a packet that has been omitted is arrived before the reordering timer expires, the packet is processed according to its sequence. When the reordering timer expires, processing is performed based on packets that have been received so far without waiting for an omitted packet, and a packet that has been arrived after the reordering timer expires is lost.

In this specification, the processing of the user plane data of the PDCP layer in the dual connectivity structure is described as an embodiment. As described above, the PDCP layer transmits data by dividing a PDCP data PDU data transmission path into an MCG and an SCG with respect to a split bearer. The PDCP layer reassembles the transmitted data on the reception side.

From a position of UE, as illustrated in Table 1, a split bearer is configured in the PDCP-Config IE field of DRB-ToAddMod within the radioBearerConfig IE of an RRC reconfiguration message through a moreThanOneRLC field. An ul-DataSplitThreshold field is used for the PDCP layer to determine the threshold of a data split in the state in which an uplink split bearer has been activated. In the ul-DataSplitThreshold field, b0 refers to 0 byte. Data is immediately split regardless of its size. When b100 is 100 bytes or more, data is split. Infinity is configured when a split bearer is not supported or an SCG is deactivated. Data is not transmitted along an SCG path.

TABLE 1
-- ASN1START
-- TAG-PDCP-CONFIG-START

| | |
|---|---|
| PDCP-Config ::= | SEQthe UENCE { |
| drb | SEQthe UENCE { |

| | |
|---|---|
| discardTimer | ENUMERATED {ms10, ms20, ms30, ms40, ms50, ms60, ms75, ms100, |

ms150, ms200,

ms250, ms300, ms500, ms750, ms1500, infinity}

OPTIONAL, -- Cond Setup

| | |
|---|---|
| pdcp-SN-SizeUL | ENUMERATED {len12bits, len18bits} |

OPTIONAL, -- Cond Setup1

| | |
|---|---|
| pdcp-SN-SizeDL | ENUMERATED {len12bits, len18bits} |

OPTIONAL, -- Cond Setup2

| headerCompression | | CHOICE { |
|---|---|---|
| | notUsed | NULL, |
| | rohc | SEQthe UENCE { |

| | |
|---|---|
| maxCID | INTEGER (1..16383) |

DEFAULT 15,

| profiles | SEQthe UENCE { |
|---|---|
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |
| }, | |
| drb-ContinueROHC | ENUMERATED { true } |

| OPTIONAL | -- Need N | |
|---|---|---|
| | }, | |
| | uplinkOnlyROHC | SEQthe UENCE { |

| | |
|---|---|
| maxCID | INTEGER (1..16383) |

DEFAULT 15,

| profiles | SEQthe UENCE { |
|---|---|
| profile0x0006 | BOOLEAN |
| }, | |
| drb-ContinueROHC | ENUMERATED { true } |

| | |
|---|---|
| OPTIONAL | -- Need N |
| | }, |
| | ... |

},

| | |
|---|---|
| integrityProtection | ENUMERATED { enabled } |

| | |
|---|---|
| OPTIONAL, | -- Cond ConnectedTo5GC1 |

| | |
|---|---|
| statusReportRequired | ENUMERATED { true } |

| | |
|---|---|
| OPTIONAL, | -- Cond Rlc-AM-UM |

| | |
|---|---|
| outOfOrderDelivery | ENUMERATED { true } |

| | |
|---|---|
| OPTIONAL | -- Need R |

}

| | |
|---|---|
| OPTIONAL, | -- Cond DRB |

| | |
|---|---|
| moreThanOneRLC | SEQthe UENCE { |

| | |
|---|---|
| the primary path | SEQthe UENCE { |

| | cellGroup | CellGroupId |
|---|---|---|
| OPTIONAL, | -- Need R | |
| | logicalChannel | LogicalChannelIdentity |

| | |
|---|---|
| OPTIONAL | -- Need R |

},

| | |
|---|---|
| ul-DataSplitThreshold | UL-DataSplitThreshold |

| | |
|---|---|
| OPTIONAL, | -- Cond SplitBearer |

| | |
|---|---|
| pdcp-Duplication | BOOLEAN |

| | |
|---|---|
| OPTIONAL | -- Need R |

}

| | |
|---|---|
| OPTIONAL, | -- Cond MoreThanOneRLC |

...
UL-DataSplitThreshold ::= ENUMERATED {

b0, b100, b200, b400, b800, b1600, b3200, b6400,

b12800, b25600, b51200, b102400, b204800,

b409600, b819200, b1228800, b1638400, b2457600,

b3276800, b4096000, b4915200, b5734400,

b6553600, infinity, spare8, spare7, spare6,

spare5, spare4, spare3, spare2, spare1}
...
-- TAG-PDCP-CONFIG-STOP
-- ASN1STOP

Table 1 illustrates an example of a PDCP-Config 1E format of an RRC message for the configuration of a split bearer in the dual connectivity structure.

When the sum of the volume of PDCP data and the volume of RLC data that waits for initial transmission is an ul-DataSplitThreshold value or more on the basis of the ul-DataSplitThreshold value of a split bearer configured through an RRC reconfiguration, a PDCP PDU is transmitted to a primary RLC entity and a split secondary RLC entity. When the sum of the volume of PDCP data and the volume of RLC data that waits for initial transmission is not the ul-DataSplitThreshold value or more, the PDCP PDU is transmitted to only the primary RLC entity.

Although the volume of data to be transmitted by UE is less than the ul-DataSplitThreshold value, in the following case, performance degradation of the UE may be caused because only a primary path is used.
1) The degradation of the transfer rate attributable to the degradation of a channel state in the primary path of UE
2) The degradation of the transfer rate attributable to a reduction in the assignment of radio resources attributable to a load of a base station corresponding to the primary path of UE

In such cases, in order to solve the performance degradation problems of the UE, it is necessary to flexibly change whether to use an MCG and an SCG simultaneously based on the volume of data to be transmitted, the channel state of UE, and a load of the base station. This specification provides method of updating the ul-DataSplitThreshold value based on PDCP control signaling.

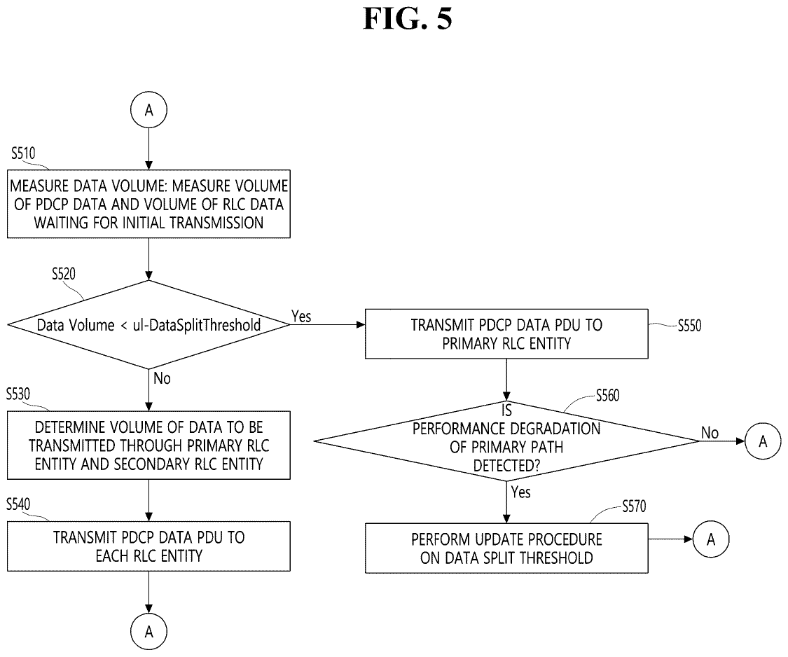

FIG. 5 is a flowchart illustrating an example of a method of updating a split bearer data split threshold in a dual connectivity structure proposed in this specification.

More specifically, as illustrated in the method of FIG. 5, for example, UE measures the volume of data to be transmitted with respect to a split bearer (S510), and checks whether the volume of data to be transmitted is less than a value that is set in the ul-DataSplitThreshold field included in a received PDCP-Config IE (S520).

When the volume of data to be transmitted is less than the value set in the ul-DataSplitThreshold field included in the received PDCP-Config IE as the result of the check, the UE checks whether performance degradation of the primary path has been detected (S560) while transmitting data to the primary RLC entity (S550). When the performance degradation is detected as the result of the check, the UE performs an update procedure on a data split threshold (S570).

When the volume of data to be transmitted is equal to or greater than the value set in the ul-DataSplitThreshold field included in the received PDCP-Config IE as the result of the check, the UE determines the volume of data to be transmitted to the primary RLC entity and the split secondary RLC entity (S530), and transmits a PDCP data PDU to each of the primary RLC entity and the split secondary RLC entity (S540).

The method proposed in FIG. 5 has advantages in that complexity is reduced and relative fast updates are possible by using an update method based on a PDCP control PDU between peer PDCPs for the update of the ul-DataSplitThreshold value. To this end, the PDCP Control PDU for the update of a data split threshold proposed in this specification is as follows.

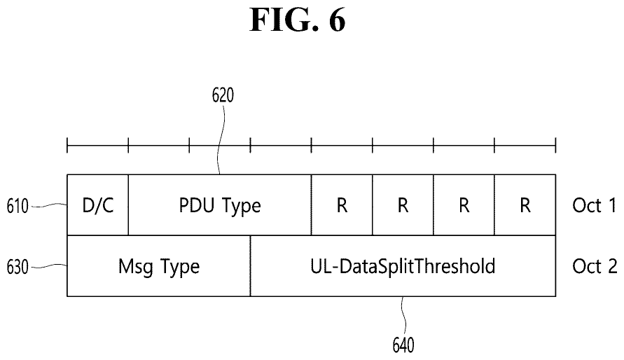

When performance degradation of the primary path is detected in the UE, the transmission PDCP entity configures a PDCP Control PDU including a data split threshold update type and transmits the PDCP Control PDU to a peer PDCP entity as illustrated in FIG. 6. FIG. 6 illustrates an example of a PDCP control PDU format for the update of a data split threshold, which is proposed in this specification. The PDCP control PDU format illustrated in FIG. 6 may include a D/C field (D/C) 610, a PDU type field (PDU Type) 620, a message type field (Msg Type) 630, and an UL-DataSplitThreshold field (UL-DataSplitThreshold) 640.

The UE configures the D/C field included in the PDCP control PDU format as 0. The reason why the D/C field is set to “0” is that the D/C field belongs to a control PDU.

Furthermore, the UE sets the PDU type field included in the PDCP control PDU format as a value indicative of a data split threshold update.

Furthermore, the message type field included in the PDCP control PDU format may be defined by the necessity of the update of the data split threshold as illustrated in Table 2. Table 2 illustrates an example of the message type field in the update of the data split threshold.
Msg Type=0: this is used when UE requests the update of a data split threshold from a base station for a reason, such as the detection of performance degradation of a primary path.
Msg Type=1: this is used for a base station as a response to the update of a data split threshold requested by UE.
Msg Type=2: this used when UE requires the update of a data split threshold based on a determination of a base station.

Furthermore, the UL-DataSplitThreshold field included in the PDCP control PDU format indicates a data split threshold value to be updated, and is used in accordance with the enum value of the UL-DataSplitThreshold field in Table 1.

TABLE 2

| Bit | Description |
|---|---|
| 000 | data split threshold update request |
| 001 | data split threshold update response |
| 010 | data split threshold update indication |
| 010-111 | Reserved |

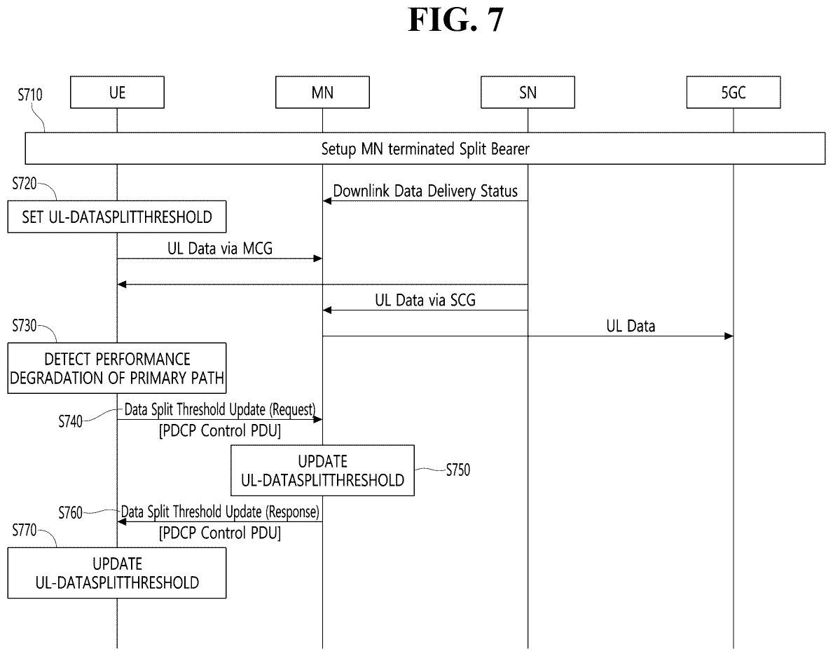

FIG. 7 is a flowchart illustrating an example of a data split threshold update method triggered in UE, which is proposed in this specification.

The method proposed in this specification is described by taking a case in which UE detects performance degradation of a primary path and performs a data split threshold update procedure when an MN-terminated split bearer has been configured in the UE (S710) as an example, as illustrated in FIG. 7.

Referring to FIG. 7, the transmission PDCP entity of the UE transmits UL data through an MCG or an SCG based on a set UL-DataSplitThreshold value (S720). When detecting performance degradation of a primary path (S730), the transmission PDCP entity of the UE configures the update of a data split threshold (Msg Type=Request) and transmits the data split threshold to a peer PDCP entity of the base station through a PDCP Control PDU (S740). The PDCP entity of the base station may update the UL-DataSplitThreshold value with a requested UL-DataSplitThreshold value within a received data split threshold update (Msg Type=Request) message or with an UL-DataSplitThreshold value determined by the base station (S750). The base station configures the data split threshold update (Msg Type=Response) including the updated UL-DataSplitThreshold value and transmits the data split threshold to the UE through a PDCP control PDU (S760). After receiving the data split threshold update (Msg Type=Response) message, the PDCP entity of the UE updates the UL-DataSplitThreshold value (S770). The base station and the UE each transmit UL data through the MCG or the SCG based on the updated UL-DataSplitThreshold value.

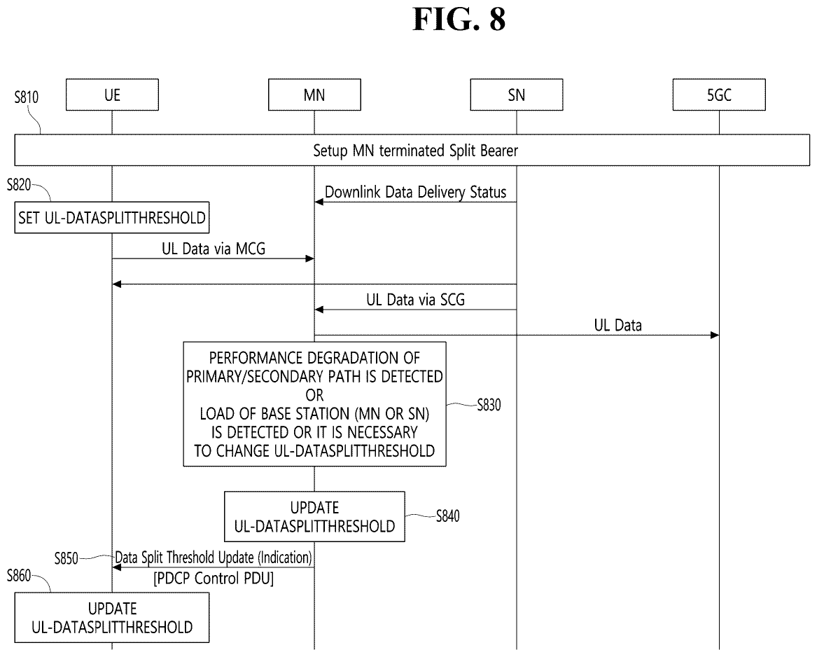

FIG. 8 is a flowchart illustrating an example of a data split threshold update method triggered in a base station, which is proposed in this specification.

The method proposed in this specification is described by taking a data split threshold update procedure that is performed by a base station when the base station detects performance degradation of a primary path or a load of the base station (MN or SN) when an MN-terminated split bearer is configured in UE (S810) as an example, as illustrated in FIG. 8.

Referring to FIG. 8, the transmission PDCP entity of the UE transmits UL data through an MCG or an SCG based on a set UL-DataSplitThreshold value (S820). When performance degradation of a primary path (or performance degradation of a secondary path) is detected in the base station or when it is necessary to change a data split threshold because a load of the base station is detected (S830), the PDCP entity of the base station configures a data split threshold update (Msg Type=Indication) message by setting an UL-DataSplitThreshold value to be updated and then transmits the message to a peer PDCP entity of the UE through a PDCP control PDU (S840 and S850). After receiving the data split threshold update (Msg Type=Indication) message, the PDCP entity of the UE updates the UL-DataSplitThreshold value (S860). The base station and the UE transmit UL data through the MCG or the SCG based on the updated UL-DataSplitThreshold value.

In the data split threshold update procedure by the base station in FIG. 8, the UL-DataSplitThreshold value may be increased or decreased by also considering performance degradation of a secondary path in addition to performance degradation of the primary path of UE for a split bearer. Furthermore, in the data split threshold update procedure by the base station in FIG. 8, the UL-DataSplitThreshold value may be flexibly adjusted by considering a load of all of the MN and SN of the base station.

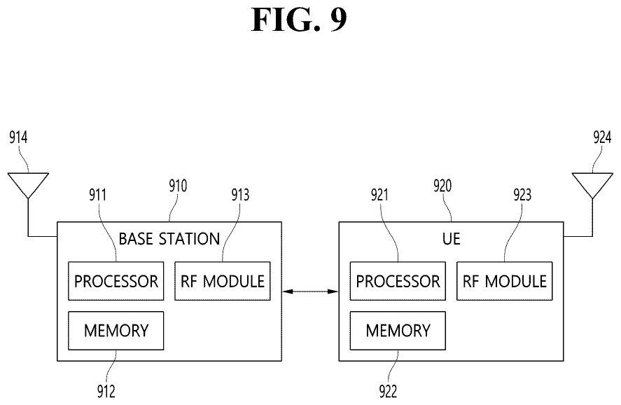

FIG. 9 illustrates a block diagram of a wireless communication apparatus to which the methods proposed in this specification may be applied.

Referring to FIG. 9, a wireless communication system includes a base station 910 and UE 920 placed in the area of the base station.

The base station and the UE may each be represented as a radio apparatus.

The base station includes a processor 911, memory 912, and a radio frequency (RF) module 913. The processor 911 implements the functions, processes and/or methods proposed with reference to FIGS. 1 to 8. The layers of a radio interface protocol may be implemented by the processor. The memory is connected to the processor, and stores various types of information for driving the processor. The RF module is connected to the processor, and transmits and/or receives a radio signal.

The UE includes a processor 921, memory 922, and an RF module 923.

The processor implements the functions, processes and/or methods proposed with reference to FIGS. 1 to 8. The layers of a radio interface protocol may be implemented by the processor. The memory is connected to the processor, and stores various types of information for driving the processor. The RF module is connected to the processor, and transmits and/or receives a radio signal.

The memory 912, 922 may be placed inside or outside the processor 911, 921, and may be connected to the processor 911, 921 through various well-known means.

Furthermore, the base station and/or the UE may have a single antenna or multiple antennas.

An antenna 914, 924 performs a function for transmitting and receiving radio signals.

In the aforementioned embodiments, the components and characteristics of the present disclosure have been combined in a specific form. Each of the components or characteristics may be considered to be optional unless otherwise described explicitly. Each of the components or characteristics may be implemented in a form that is not combined with other components or characteristics. Furthermore, some of the components or the characteristics may be combined to form an embodiment of the present disclosure. The sequence of the operations described in the embodiments of the present disclosure may be changed. Some of the components or characteristics of an embodiment may be included in another embodiment or may be replaced with corresponding components or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDS), programmable logic devices (PLDs), field programmable gate arrays (FPGAS), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be embodied in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### DESCRIPTION OF REFERENCE NUMERAL

10: wireless communication system

What is claimed is:

1. A method of controlling a split bearer in a wireless communication system supporting dual connectivity, the method performed by user equipment (UE) comprising:
receiving an RRC message, comprising first control information related to a configuration of a split bearer and second control information related to a setting of a data split threshold, from a base station;
setting a split threshold of uplink data based on the second control information with respect to the split bearer configured based on the first control information;
transmitting a first PDCP control PDU that requests an update of the set split threshold of the uplink data to the base station;
receiving a second PDCP control PDU corresponding to a response to the first PDCP control PDU from the base station; and
updating the split threshold of the uplink data based on the second PDCP control PDU.

2. The method of claim 1, wherein:
the first control information is a moreThanOneRLC field, and
the second control information is an UL-DataSplitThreshold field.

3. The method of claim 2, wherein the first PDCP control PDU and the second PDCP control PDU each comprise a D/C field, a PDU type field, a message type field, and an UL-DataSplitThreshold field.

4. The method of claim 3, wherein the PDU type field included in the first PDCP control PDU is set as a value indicative of the update of the data split threshold.

5. The method of claim 4, wherein:
the message type field included in the first PDCP control PDU is set as a value requesting the update of the data split threshold, and
the message type field included in the second PDCP control PDU is set as a value indicative of a response to a request for the update of the data split threshold.

6. The method of claim 1, further comprising:
measuring a volume of data to be transmitted based on the configured split bearer; and
comparing the measured volume of the data and the set split threshold of the uplink data.

7. The method of claim 6, wherein the volume of the data is measured based on a sum of the volume of PDCP data and the volume of RLC data that waits for initial transmission.

8. The method of claim 6, wherein when the measured volume of the data is equal to or greater than the set split threshold of the uplink data, a PDCP data PDU is transmitted from a PDCP entity to a primary RLC entity and a split secondary RLC entity.

9. The method of claim 6, wherein when the measured volume of the data is smaller than the set split threshold of the uplink data, a PDCP data PDU is transmitted from a PDCP entity to a primary RLC entity.

10. The method of claim 1, wherein when performance degradation is detected in the primary RLC entity, updates are performed on the split threshold of the uplink data.

11. A method of controlling a split bearer in a wireless communication system supporting dual connectivity, the method performed by a base station comprising:
transmitting an RRC message, comprising first control information related to a configuration of a split bearer and second control information related to a setting of a threshold for a data split, to UE;
updating a split threshold of uplink data when the split threshold of the uplink data configured based on the second control information needs to be changed; and
transmitting a PDCP control PDU comprising the updated split threshold of the uplink data to the UE.

12. The method of claim 11, wherein:
the first control information is a moreThanOneRLC field, and
the second control information is an UL-DataSplitThreshold field.

13. The method of claim 12, wherein the PDCP control PDU comprises a D/C field, a PDU type field, a message type field, and an UL-DataSplitThreshold field.

14. The method of claim 13, wherein the message type field included in the PDCP control PDU is set as a value indicative of an update of a data split threshold.

15. The method of claim 11, wherein when performance degradation is detected in at least one of a primary path or secondary path for the split bearer, updates are performed on the split threshold of the uplink data.

16. The method of claim 11, wherein when a load of the base station is detected, updates are performed on the split threshold of the uplink data.

17. User equipment for controlling a split bearer in a wireless communication system supporting dual connectivity, the UE comprising:
an RF module configured to transmit and receive radio signals to and from a base station; and
a processor functionally connected to the RF module and configured to control an overall operation of the UE,
wherein the processor controls to:
receive an RRC message, comprising first control information related to a configuration of a split bearer and second control information related to a setting of a data split threshold, from a base station,
set a split threshold of uplink data based on the second control information with respect to the split bearer configured based on the first control information,
transmit a first PDCP control PDU that requests an update of the set split threshold of the uplink data to the base station,
receive a second PDCP control PDU corresponding to a response to the first PDCP control PDU from the base station, and
update the split threshold of the uplink data based on the second PDCP control PDU.

18. The UE of claim 17, wherein the processor controls to measure a volume of data to be transmitted based on the configured split bearer and to compare the measured volume of the data and the set split threshold of the uplink data.

19. The UE of claim 18, wherein the processor measures the volume of the data as a sum of a volume of PDCP data and a volume of RLC data that waits for initial transmission.

20. The UE of claim 19, wherein the processor transmits a PDCP data PDU from a PDCP entity to a primary RLC entity when the measured volume of the data is smaller than the set split threshold of the uplink data, and performs updates on the split threshold of the uplink data when performance degradation is detected in the primary RLC entity.
